(19) United States
(12) Patent Application Publication
(10) Pub. No.: US 2021/0316591 A1
(43) Pub. Date: Oct. 14, 2021

(54) COOLING SYSTEM OF VEHICLE

(71) Applicants: Hyundai Motor Company, Seoul (KR); Kia Motors Corporation, Seoul (KR)

(72) Inventors: Dae Kwang Kim, Yongin (KR); Young Ho Jung, Seoul (KR); Cheol Soo Park, Yongin (KR)

(21) Appl. No.: 16/934,504

(22) Filed: Jul. 21, 2020

(30) Foreign Application Priority Data
Apr. 10, 2020 (KR) 10-2020-0044323

(51) Int. Cl. B60H 1/00; B60H 1/32; F25B 21/04

(52) U.S. Cl. CPC B60H 1/00571; F25B 21/04; B60H 1/32

(57) ABSTRACT

A cooling system of a vehicle includes a first refrigerant line that circulates a refrigerant between an engine and a first radiator, a second refrigerant line that circulates the refrigerant between a thermoelectric module and a second radiator for producing electric power from heat in an exhaust gas exhausted from the engine, a supply line that connects an upstream side of the engine in the first refrigerant line and an upstream side of the thermoelectric module in the second refrigerant line to supply the refrigerant in the first refrigerant line to the second refrigerant line, and a return line that connects a downstream side of the thermoelectric module in the second refrigerant line and a downstream side of the engine in the first refrigerant line to return the refrigerant in the second refrigerant line to the first refrigerant line.

### CROSS-REFERENCE TO RELATED APPLICATION

This application claims under 35 U.S.C. § 119(a) the benefit of Korean Patent Application No. 10-2020-0044323, filed in the Korean Intellectual Property Office on Apr. 10, 2020, the entire contents of which are incorporated herein by reference.

### BACKGROUND

### (a) Technical Field

The present disclosure relates to a cooling system of a vehicle.

### (b) Description of the Related Art

Generally, a vehicle obtains energy by burning fuel in an engine. Here, about 30% of chemical energy of the fuel is converted into mechanical energy, and the rest of the energy is released in the form of heat. In particular, the heat generated from the engine is transferred by a refrigerant and is released through a radiator or is discharged in the form of exhaust gas.

The exhaust gas typically discharges heat having the highest temperature, and is generally discharged to the outside through an exhaust line. Accordingly, techniques for recovering exhaust heat of the exhaust gas have been developed to improve thermal efficiency of the engine.

Among the techniques, a thermal electric generator (TEG), which is referred to as thermoelectric power generation, is a system for producing electric energy with the exhaust heat. For thermoelectric power generation, the TEG should be equipped with a device that recovers heat from high-temperature exhaust gas and generates power, and should include a separate low-temperature device to generate a temperature difference.

A low-temperature device of a conventional thermoelectric power generation system, as shown in FIG. 1 (RELATED ART), separately constitutes a circuit or adopts a method that is connected to a cooling circuit existing in the engine. In a case of constituting the separate circuit, a power generation amount increases, but the heat energy recovered from a high-temperature device of a thermoelectric module may not be utilized. In a case of connecting to the cooling circuit of the engine, because a temperature of a refrigerant flowing into the low-temperature device after passing through the engine is relatively high, a temperature difference between the high-temperature device and the low-temperature device decreases, resulting in a decrease in power production.

### SUMMARY

An aspect of the present disclosure provides a cooling system of a vehicle which is capable of efficiently producing power of a thermoelectric module and improving fuel efficiency.

According to an aspect of the present disclosure, a cooling system of a vehicle includes a first refrigerant line that circulates a refrigerant between an engine and a first radiator, a second refrigerant line that circulates the refrigerant between a thermoelectric module and a second radiator for producing electric power from heat in an exhaust gas exhausted from the engine, a supply line that connects an upstream side of the engine in the first refrigerant line and an upstream side of the thermoelectric module in the second refrigerant line to supply the refrigerant in the first refrigerant line to the second refrigerant line, and a return line that connects a downstream side of the thermoelectric module in the second refrigerant line and a downstream side of the engine in the first refrigerant line to return the refrigerant in the second refrigerant line to the first refrigerant line.

In an embodiment, the first refrigerant line may include a main line being a closed loop to connect the engine to the first radiator, and a bypass line that connects the upstream side to the downstream side of the first radiator in the main line to bypass a refrigerant in the main line to a heater core for heating the vehicle, and the return line may be provided to connect the downstream side of the thermoelectric module in the second refrigerant line and an upstream side of the heater core in the bypass line.

In another embodiment, the cooling system of a vehicle may further include a second pump that is provided in the second refrigerant line and pressurizes and transmits the refrigerant in the second refrigerant line, a valve provided in the supply line to control whether the supply line is opened or closed, and a controller that controls the second pump and the valve based on a temperature of the refrigerant in the first refrigerant line.

In another embodiment, the cooling system of a vehicle may further include a first pump that is provided in the main line and pressurizes and transmits the refrigerant in the main line.

In another embodiment, the first pump may be provided at an upstream side of a connection point of the main line and the supply line, and the second pump may be provided at an upstream side of a connection point of the second refrigerant line and the supply line.

In another embodiment, the controller may control the valve to be opened and the second pump not to be operated when a temperature of the refrigerant passing through the engine is less than a first reference temperature.

In another embodiment, the controller may control the valve to be closed and the second pump to be operated when the temperature of the refrigerant passing through the engine is greater than the first reference temperature and less than a second reference temperature higher than the first reference temperature.

In another embodiment, the controller may control the valve to be opened, and the second pump to be operated or not to be operated when the temperature of the refrigerant passing through the engine is greater than the second reference temperature and the temperature of the refrigerant in the second refrigerant line is higher than the temperature of the refrigerant in the first refrigerant line.

In another embodiment, the cooling system of a vehicle may further include a valve that controls whether to connect between the first and second refrigerant lines through the supply line, and a controller that controls the valve based on a temperature of the refrigerant in the first refrigerant line.

### BRIEF DESCRIPTION OF THE DRAWINGS

The above and other objects, features and advantages of the present disclosure will be more apparent from the following detailed description taken in conjunction with the accompanying drawings:

FIG. 1 (RELATED ART) is a diagram conceptually illustrating a conventional cooling system of a vehicle;

FIG. 2 is a diagram conceptually illustrating a cooling system of a vehicle according to an embodiment of the present disclosure;

FIG. 3 is a diagram illustrating refrigerant circulation when the cooling system of the vehicle of FIG. 2 is in a cold starting mode;

FIG. 4 is a diagram illustrating refrigerant circulation when the cooling system of the vehicle of FIG. 2 is in a power generation maximization mode;

FIG. 5 is a diagram illustrating refrigerant circulation when the cooling system of the vehicle of FIG. 2 is in a system cooling mode; and

FIG. 6 is a flowchart illustrating operation of a controller of the cooling system of the vehicle of FIG. 2.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

<Basic Structure of Cooling System>

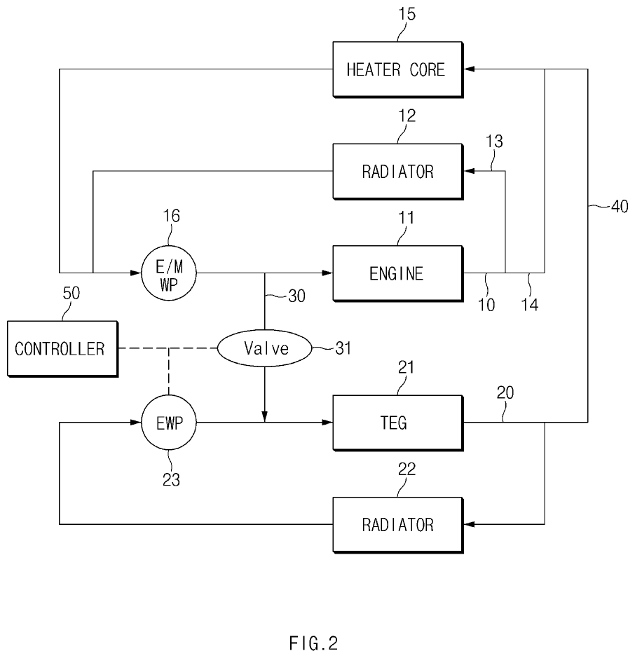

A cooling system according to an embodiment of the present disclosure relates to a cooling system of a vehicle. As shown in FIG. 2, the cooling system of the vehicle according to an embodiment of the present disclosure includes a first refrigerant line 10, a second refrigerant line 20, a supply line 30, and a return line 40. FIG. 2 is a diagram conceptually illustrating a cooling system of a vehicle according to an embodiment of the present disclosure. A high-temperature part of a thermoelectric module 21, that is, a portion through which exhaust gas passes, is omitted from FIG. 2.

The first refrigerant line 10 may be provided to circulate a refrigerant between an engine 11 and a first radiator 12. The refrigerant may be an engine coolant. The first radiator 12 may cool the refrigerant by exchanging heat between the air flowing outside and the refrigerant inside. The first radiator 12 may include a pair of header tanks, tubes having both ends fixed to the header tanks to form a refrigerant passage, and pins disposed between the tubes.

The second refrigerant line 20 may be provided to circulate the refrigerant between the thermoelectric module 21 and a second radiator 22. The thermoelectric module 21 is a device for producing electric power from heat in an exhaust gas exhausted from the engine 11. The thermoelectric module 21 may use a Seebeck effect in which electromotive force is generated when a temperature difference is applied to both ends of a metal wire. In the thermoelectric module 21, the exhaust gas may be used as a high-temperature device and a line through which the refrigerant flows may be used as a low-temperature device. In FIG. 2, the high-temperature device through which the exhaust gas flows is omitted.

The second radiator 22 may perform heat exchange similarly to the first radiator 12.

The supply line 30 connects an upstream side of the engine 11 in the first refrigerant line 10 to an upstream side of the thermoelectric module 21 in the second refrigerant line 20 to supply the refrigerant in the first refrigerant line 10 to the second refrigerant line 20. Here, the upstream side refers to an opposite side of a direction in which the refrigerant flows. In FIG. 2, the upstream side of the engine 11 corresponds to an inlet side located on a left side of the engine 11. The refrigerant to be introduced into the engine may flow to the thermoelectric module 21 through the supply line 30.

The return line 40 connects a downstream side of the engine 11 in the first refrigerant line 10 to a downstream side of the thermoelectric module 21 in the second refrigerant line 20 to return the refrigerant in the second refrigerant line 20 to the first refrigerant line 10. Here, the downstream side refers to a side of a direction in which the refrigerant flows. In FIG. 2, the downstream side of the thermoelectric module 21 corresponds to an outlet side located on a right side of the thermoelectric module 21. The refrigerant supplied from the supply line 30 and passed through the thermoelectric module 21 may flow through the first refrigerant line 10 through the return line 40. The return line 40 may include a return valve (not shown) that opens and closes the return line 40.

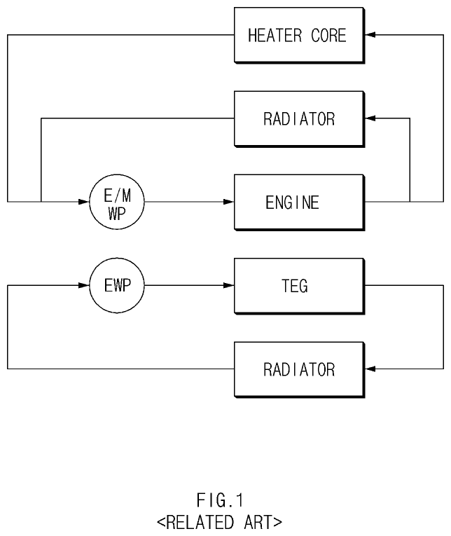

The low-temperature device of the conventional thermoelectric module, as shown in FIG. 1 (RELATED ART), separately constitutes a circuit or adopts a method that is connected to a cooling circuit existing in the engine. In the case of a separate circuit, a power generation amount increases, but the heat energy recovered from the high-temperature device of the thermoelectric module may not be utilized. In the case of connecting to the cooling circuit of the engine, because the temperature of the refrigerant flowing into the low-temperature device after passing through the engine is relatively high, the temperature difference between the high-temperature device and the low-temperature device decreases, resulting in a decrease in power production.

According to the present disclosure, the first refrigerant line 10 may be connected to the second refrigerant line 20 to secure the efficiency of power generation. For example, when the cooling of the engine 11 becomes unnecessary or the need for cooling is reduced, the refrigerant cooled to be introduced into the engine 11 in the first refrigerant line 10 may be introduced into the second refrigerant line 20 to be used as a low-temperature device of the thermoelectric module 21, thereby efficiently producing power.

First Refrigerant Line

The first refrigerant line 10 may include a main line 13 and a bypass line 14. The main line 13 may be formed in a closed loop connecting the engine 11 to the first radiator 12. The bypass line 14 may be provided to connect the upstream side to the downstream side of the first radiator 12 in the main line 13 to bypass the refrigerant in the main line 13 to a heater core 15. The heater core 15 is a device including a heater that performs heating of the vehicle. For heating the vehicle interior, the refrigerant may be circulated along the bypass line 14 connecting the engine 11 to the heater core 15, and the refrigerant recovering the heat from the low-temperature device of the thermoelectric module 21 may be introduced into the heater core 15 to exchange the heat with the air to be supplied to the vehicle interior.

The return line 40 may be provided to connect the downstream side of the thermoelectric module 21 in the second refrigerant line 20 to the upstream side of the heater core 15 in the bypass line 14. The refrigerant supplied from the supply line 30 and passed through the thermoelectric module 21 may flow through the return line 40 to the heater core 15.

First Pump

The cooling system of the vehicle according to an embodiment of the present disclosure may include a first pump 16. The first pump 16, which is in the main line 13, may be provided to pressurize and transmit the refrigerant in the main line 13. The refrigerant may be pressurized by the first pump 16 to be circulated through the first refrigerant line 10. The first pump 16 may be an electric pump that drives a motor using electricity to pressurize and transmit the refrigerant, or may be a mechanical pump. The first pump 16 may be provided at an upstream side of a connection point between the main line 13 and the supply line 30.

Second Pump, Valve, and Controller

The cooling system of the vehicle according to an embodiment of the present disclosure may further include a second pump 23, a valve 31, and a controller 50. The second pump 23, which is in the second refrigerant line 20, may be provided to pressurize and transmit the refrigerant in the second refrigerant line 20. The refrigerant may be pressurized by the second pump 23 to be circulated through the second refrigerant line 20. The second pump 23 may be an electric pump that drives a motor using electricity to pressurize and transmit the refrigerant. The second pump 23 may be provided at an upstream side of a connection point between the second refrigerant line 20 and the supply line 30. The second pump 23 allows the refrigerant to be circulated in the second refrigerant line 20, thereby introducing into the thermoelectric module 21.

Various Examples of Valve

The valve 31 may be provided in the supply line 30 to control whether the supply line 30 is opened or closed. The valve may be provided in the supply line to be a general valve that controls whether the supply line 30 is opened or closed. Alternatively, the valve may be a three-way valve to be connected to a point where the supply line 30 and the first refrigerant line 10 meet. Otherwise, the valve may be a three-way valve to be connected to a point where the supply line 30 and the second refrigerant line 20 meet. As the valve 31 controls whether the supply line 30 is opened or closed, the valve 31 may be provided to control whether or not connect between the first and second refrigerant lines 10 and 20 through the supply line 30. That is, when the supply line 30 is opened by the valve 31, the refrigerant of the first refrigerant line 10 may flow into the second refrigerant line 20. When the supply line is closed by the valve 31, the refrigerant in the first refrigerant line 10 may not flow into the second refrigerant line 20.

<Detailed Description of Controller>

The controller 50 may be provided to control the second pump 23 and the valve 31 based on a temperature of the refrigerant in the first refrigerant line 10. The controller 50 may include a processor and a memory. The processor may include a microprocessor such as a field programmable gate array (FPGA), an application specific integrated circuit (ASIC), and a central processing unit (CPU). The memory may store instructions that are basis for generating an instruction for determining whether to open or close the valve in the processor. The memory may be a data store such as a hard disk drive (HDD), a solid state drive (SSD), a volatile medium, or a nonvolatile medium.

Controlling of Controller

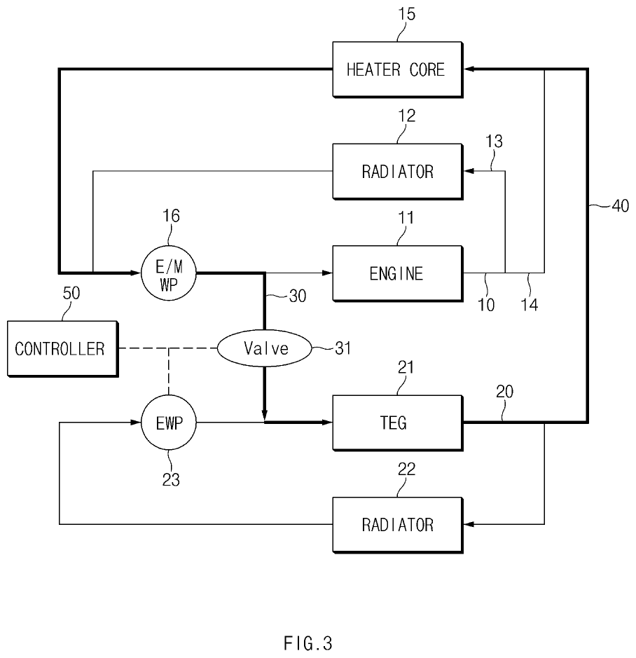

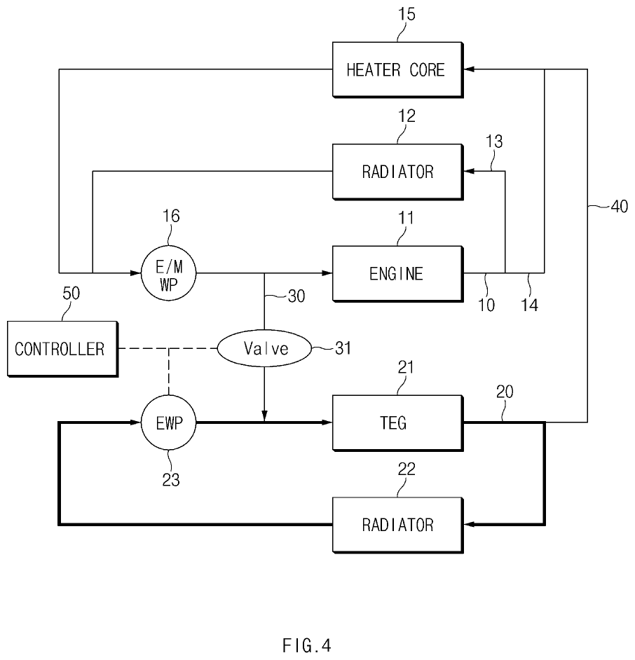

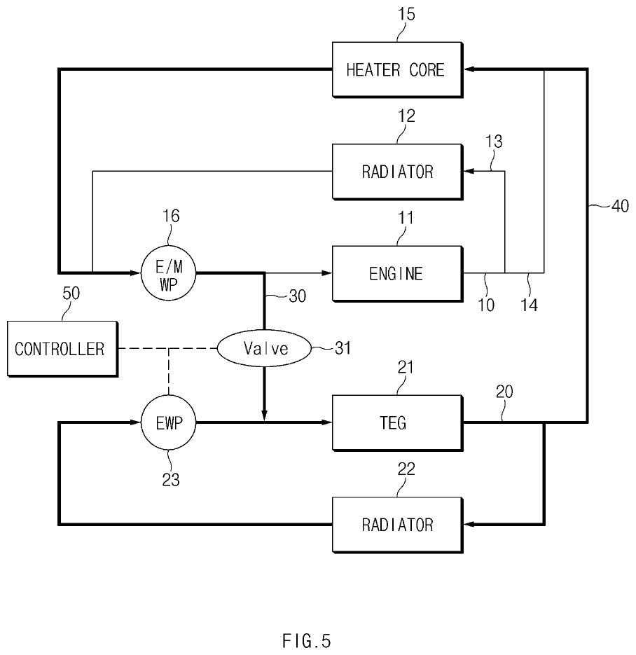

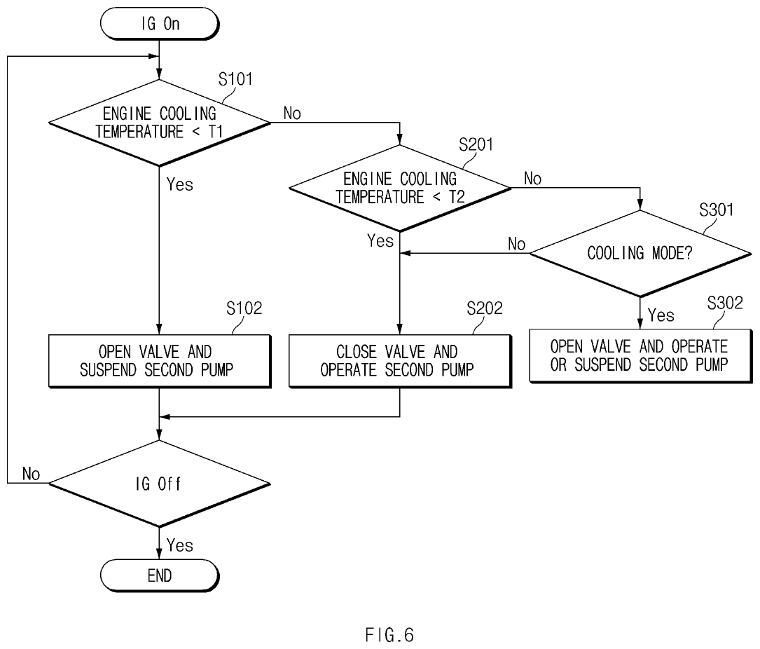

Hereinafter, controlling the cooling system of the vehicle according to an embodiment of the present disclosure will be described. FIG. 3 is a diagram illustrating refrigerant circulation when the cooling system of the vehicle is in a cold starting mode. FIG. 4 is a diagram illustrating refrigerant circulation when the cooling system of the vehicle is in a power generation maximization mode. FIG. 5 is a diagram illustrating refrigerant circulation when the cooling system of the vehicle is in a system cooling mode. FIG. 6 is a flowchart illustrating operation of the controller.

Control in Cold Starting Mode

Hereinafter, control in a cold starting mode will be described in detail with reference to FIGS. 3 and 6. The cold starting mode means that a temperature of the refrigerant is less than a first reference temperature T1 when the refrigerant passes through the engine 11 and is then measured. The first reference temperature T1 may be about 80 degrees Celsius. The controller 50 determines whether the cold starting mode is present (S101, FIG. 6). When the cold starting mode is determined in the controller 50, the controller 50 may control the valve 31 to be opened, and the second pump 23 may be controlled not to be operated (S102, FIG. 6). In FIG. 3, a part indicated by a bold line illustrates a circulation of refrigerant which is newly generated when the cold starting mode is determined, and a general flow of the refrigerant required for cooling the engine is omitted. For example, the refrigerant may flow in the main line 13.

In the case of the cold starting mode, some refrigerant to be introduced into the engine 11 may be introduced into the thermoelectric module 21 using the first pump 16 because the cooling of the engine 11 becomes unnecessary or the need for cooling is reduced. Therefore, efficient power generation is possible. In this case, the operation of the second pump 23 may be suspended to minimize power consumption.

In addition, in the case of the cold starting mode, the refrigerant passing through the thermoelectric module 21 to recover heat may pass through the heater core 15 to assist heating the interior of the vehicle, and the refrigerant passing through the thermoelectric module 21 to recover heat may pass through the engine 11 to assist warm-up of the engine 11.

Control in Power Generation Maximization Mode

Hereinafter, control in a power generation maximization mode will be described with reference to FIGS. 4 and 6. The power generation maximization mode means when a temperature of the refrigerant passing through the engine 11 is greater than the first reference temperature T1 and less than a second reference temperature T2 higher than the first reference temperature T1. The second reference temperature T2 may be about 105 degrees Celsius.

The controller 50 determines whether the power generation maximization mode is present (S201, FIG. 6). When the power generation maximization mode is determined in the controller 50, the controller 50 may control the valve 31 to be closed and the second pump 23 to be operated (S202, FIG. 6). In FIG. 4, a part indicated by a bold line illustrates a circulation of refrigerant which is newly generated when the power generation maximization mode is determined and a general flow of the refrigerant required for cooling the engine is omitted. For example, the refrigerant may flow in the main line 13.

In the case of the power generation maximization mode, the refrigerant of the second refrigerant line 20 may be circulated to the thermoelectric module 21, and the refrigerant of the first refrigerant line 10 may not be introduced into the second refrigerant line 20. In the case of the power generation maximization mode, when refrigerant flowing into the low-temperature device of the thermoelectric module 21 and the refrigerant of the first refrigerant line 10 are mixed, the efficiency of power generation may be reduced because the refrigerant temperature of the first refrigerant line 10 is sufficiently high. Therefore, the valve 31 may be suspended to allow the refrigerant of the first refrigerant line 10 not to flow into the second refrigerant line 20.

In addition, in the case of the power generation maximization mode, an operation of the second pump 23 may be started to maximize production of power.

Control in System Cooling Mode

Hereinafter, control in a system cooling mode will be described in detail with reference to FIGS. 5 and 6. The system cooling mode means when the temperature of the refrigerant passing through the engine 11 is greater than the second reference temperature T2 or when the temperature of the refrigerant in the second refrigerant line 20 is greater than the second reference temperature T2, and the temperature of the refrigerant in the second refrigerant line 20 is higher than the temperature of the refrigerant in the first refrigerant line 10. That is, compared to the case of circulating the refrigerant through the second refrigerant line 20, the valve 31 may be opened to introduce the refrigerant in the first refrigerant line 10, and therefore the temperature of the refrigerant introduced into the low-temperature device of the thermoelectric module 21 may be lowered and a flow rate may be increased.

The controller 50 determines whether the system cooling mode is present (S301, FIG. 6). When the system cooling mode is determined in the controller 50, the controller 50 may control the valve 31 to be opened, and the second pump 23 to be operated or not to be operated (S302, FIG. 6). In FIG. 5, a part indicated by a bold line illustrates a circulation of refrigerant which is newly generated when the system cooling mode is determined and a general flow of the refrigerant required for cooling the engine is omitted. For example, the refrigerant may flow in the main line 13.

In the case of the system cooling mode, the valve 31 may be opened, and the controller 50 may control the second pump 23 to be operated to allow the refrigerant of the first refrigerant line 10 to additionally be introduced into the second refrigerant line 20, thereby cooling the refrigerant in the second refrigerant line 20 flowing to the low-temperature device of the thermoelectric module 21. In addition, it is possible to allow more refrigerant to flow into the low-temperature device of the thermoelectric module 21 than before. The refrigerant having a lower temperature may be introduced into the low-temperature device of the thermoelectric module 21 at an increased flow rate to be advantageous for power generation. When the temperature of the refrigerant flowing into the low-temperature device of the thermoelectric module 21 increases more than necessary due to the refrigerant in the second refrigerant line 20, the controller 50 may suspend operation of the second pump 23 when a net output does not increase. The net output refers to a value excluding an amount of power required to drive the second pump 23 from an amount of power produced by the thermoelectric module 21.

According to the present disclosure, when the cooling of the engine becomes unnecessary or the need for cooling is reduced, the refrigerant on the first refrigerant line cooled to flow into the engine flows into the second refrigerant line to be used as the low-temperature device of the thermoelectric module, thereby efficiently producing power.

In addition, according to the present disclosure, the heat recovered from the low-temperature device of the thermoelectric module may be transferred to the heater core to allow the heat recovered from the low-temperature device of the thermoelectric module to be utilized to heat the interior of the vehicle. The heat recovered from the low-temperature device of the thermoelectric module may be transferred to the engine to configure fast warm-up of the engine, thereby improving fuel efficiency.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

1. A cooling system of a vehicle, comprising:
a first refrigerant line configured to circulate a refrigerant between an engine and a first radiator;
a second refrigerant line configured to circulate the refrigerant between a thermoelectric module and a second radiator for producing electric power from heat in an exhaust gas exhausted from the engine;
a supply line configured to connect an upstream side of the engine in the first refrigerant line and an upstream side of the thermoelectric module in the second refrigerant line to supply the refrigerant in the first refrigerant line to the second refrigerant line; and
a return line configured to connect a downstream side of the thermoelectric module in the second refrigerant line and a downstream side of the engine in the first refrigerant line to return the refrigerant in the second refrigerant line to the first refrigerant line.

2. The cooling system of the vehicle of claim 1, wherein the first refrigerant line includes:
a main line being a closed loop to connect the engine to the first radiator; and
a bypass line configured to connect the upstream side to the downstream side of the first radiator in the main line to bypass a refrigerant in the main line to a heater core for heating the vehicle,
wherein the return line is configured to connect the downstream side of the thermoelectric module in the second refrigerant line and an upstream side of the heater core in the bypass line.

3. The cooling system of the vehicle of claim 2, further comprising:
a second pump provided in the second refrigerant line and configured to pressurize and transmit the refrigerant in the second refrigerant line;
a valve provided in the supply line to control whether the supply line is opened or closed; and
a controller configured to control the second pump and the valve based on a temperature of the refrigerant in the first refrigerant line.

4. The cooling system of the vehicle of claim 3, further comprising:
a first pump provided in the main line and configured to pressurize and transmit the refrigerant in the main line.

5. The cooling system of the vehicle of claim 4, wherein the first pump is provided at an upstream side of a connection point of the main line and the supply line, and
wherein the second pump is provided at an upstream side of a connection point of the second refrigerant line and the supply line.

6. The cooling system of the vehicle of claim 3, wherein the controller controls the valve to be opened and the second pump not to be operated when a temperature of the refrigerant passing through the engine is less than a first reference temperature.

7. The cooling system of the vehicle of claim 6, wherein the controller controls the valve to be closed and the second pump to be operated when the temperature of the refrigerant passing through the engine is greater than the first reference temperature and less than a second reference temperature higher than the first reference temperature.

8. The cooling system of the vehicle of claim 7, wherein the controller controls the valve to be opened, and the second pump to be operated or not to be operated when the temperature of the refrigerant passing through the engine is greater than the second reference temperature and the temperature of the refrigerant in the second refrigerant line is higher than the temperature of the refrigerant in the first refrigerant line.

9. The cooling system of the vehicle of claim 1, further comprising:
a valve configured to control whether to connect between the first and second refrigerant lines through the supply line; and
a controller configured to control the valve based on a temperature of the refrigerant in the first refrigerant line.
